(19) United States
(12) Patent Application Publication
(10) Pub. No.: US 2008/0130455 A1
(43) Pub. Date: Jun. 5, 2008

(54) Digital demodulating apparatus and controlling method thereof

(75) Inventors: Nobuyoshi Kaiki, Nara-shi (JP); Takae Sakai, Osaka (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/889,143

(22) Filed: Aug. 9, 2007

(30) Foreign Application Priority Data
Dec. 5, 2006 (JP) 2006-328266

(51) Int. Cl. G11B 20/18

(52) U.S. Cl. 369/53.35

(57) ABSTRACT

A digital demodulating apparatus includes a supplying unit that supplies power to each of circuit elements constituting a receiving unit that receives a signal, and a demodulating unit that demodulates the received signal. The apparatus further includes a correcting unit that corrects errors due to noises generated on a transmission path of the received signal; a calculating unit that calculates a value indicating the quantity of noises contained in the signal when the correcting unit corrects the errors; a judging unit that judges whether or not reception conditions of the received signal are good in a predetermined time period, based on values calculated by the calculating unit; and a reducing unit that reduces the power to be supplied to each circuit element by the supplying unit, when the judging unit decides that the reception conditions are good. The judging unit judges the reception conditions based on values repeatedly calculated by the calculating unit in the predetermined time period after a value calculated by the calculating unit indicates that the noises have become not more than a predetermined reference quantity.

### BACKGROUND OF THE INVENTION

1. Field of the Invention

The present invention relates to a digital demodulating apparatus and a controlling method of the apparatus.

2. Description of Related Art

In an apparatus that receives a modulated signal and demodulates it, a certain degree of intensity of power to be supplied to each circuit element must be ensured in order to obtain an accurately demodulated signal. Required intensity of power to supply varies in accordance with reception conditions of the signal. For example, in a circuit element, the power to supply must be increased when reception conditions are not good. In good reception conditions, however, the power to supply need not be increased so much. Therefore, to reduce the power consumption, it is thinkable that the power to be supplied to each circuit element is controlled in accordance with reception conditions of the signal.

An apparatus disclosed in Japanese Patent Unexamined Publication No. 2005-33671 receives TV broadcasting and demodulates the signal of the broadcasting to reproduce sounds and images. In this apparatus, the power to be supplied to each circuit element is controlled in accordance with reception conditions. More specifically, power supply to a signal receiver is stopped when the reception level of the signal is not more than a threshold, and the power supply is restarted when the reception level exceeds the threshold. Because the power supply is stopped when the reception level is extremely bad, the power consumption is reduced.

In the apparatus of the above publication, however, the power supply is stopped immediately after the reception level becomes not more than the threshold, and the power supply is started immediately after the reception level exceeds the threshold. In this construction, the power supply may be stopped or started in accordance with a merely temporal change in reception conditions. For example, when the reception level being not more than the threshold temporarily increases to exceed the threshold and then immediately returns to a level not more than the threshold, the power supply may be started in accordance with the temporal increase in the reception level, and the power may be kept being supplied even after the reception level returns to the level not more than the threshold. Thus, in the construction in which the power to supply is changed immediately after reception conditions change, as disclosed in the above publication, the power supply can not properly be controlled in accordance with a change in reception conditions.

### SUMMARY OF THE INVENTION

An object of the present invention is to provide a digital demodulating apparatus and a controlling method of the apparatus, wherein power can properly be supplied in accordance with a change in reception conditions including a temporal change.

According to an aspect of the present invention, a digital demodulating apparatus comprises a plurality of circuit elements constituting a receiving unit and a demodulating unit that demodulates a signal received by the receiving unit; a supplying unit that supplies power to each circuit element; a correcting unit that corrects errors due to noises generated on a transmission path of the received signal; a calculating unit that calculates a value indicating the quantity of noises contained in the signal when the correcting unit corrects the errors; a judging unit that judges whether or not reception conditions of the received signal are good in a predetermined time period, on the basis of values repeatedly calculated by the calculating unit in the predetermined time period after a value calculated by the calculating unit indicates that the noises have become not more than a predetermined reference quantity; and a reducing unit that reduces the power to be supplied to each circuit element by the supplying unit, when the judging unit decides that the reception conditions are good.

According to another aspect of the present invention, a controlling method of a digital demodulating apparatus comprising a plurality of circuit elements constituting a receiving unit and a demodulating unit that demodulates a signal received by the receiving unit; and a supplying unit that supplies power to each circuit element, comprises a correcting step of correcting errors due to noises generated on a transmission path of the received signal; a calculating step of calculating a value indicating the quantity of noises contained in the signal when the errors are corrected in the correcting step; a judging step of judging whether or not reception conditions of the received signal are good in a predetermined time period, on the basis of values repeatedly calculated in the calculating step in the predetermined time period after a value calculated in the calculating step indicates that the noises have become not more than a predetermined reference quantity; and a reducing step of reducing the power to be supplied to each circuit element by the supplying unit, when it is decided in the judging step that the reception conditions are good.

According to the invention, even when a calculated value indicates that the quantity of noises has become not more than the reference quantity, calculation of a value indicating the quantity of noises is repeated a plurality of times in the predetermined time period after the calculation of the value indicating that the quantity of noises has become not more than the reference quantity. On the basis of the calculated values, it is judged whether or not the reception conditions are good. Thus, only when the reception conditions are temporarily improved, it is not decided that the reception conditions are good. This makes it possible to more properly reduce the power to supply. Because the power to supply is reduced when it is decided that the reception conditions are good, this suppresses the power consumption of the whole of the apparatus.

In the present invention, it is preferable that the received signal is in the form of a signal train in which a plurality of unit signals each having a predetermined length are successively arranged, the correcting unit corrects with respect to each unit signal the errors due to the noises generated on the transmission path of the signal train, the calculating unit calculates a mean value of values indicating the respective quantities of noises with respect to a plurality of unit signals, on the basis of the quantities of corrections performed by the correcting unit with respect to the plurality of unit signals, and the judging unit judges whether or not the reception conditions of the received signal are good in the predetermined time period, on the basis of mean values repeatedly calculated by the calculating unit in the predetermined time period after a mean value calculated by the calculating unit indicates that the noises have become not more than the predetermined reference quantity. When the reception conditions change in a time period shorter than the length of a unit signal, if the power to supply is controlled in accordance with the change in such a short time period, the power may be frequently changed or the control can not follow the change in the reception conditions. Thus, proper control can not be performed. According to the above feature, however, when correction is performed with respect to each unit signal, a mean value of values each indicating the intensity of corrected noise is calculated with respect to a plurality of unit signals. On the basis of the mean value, the power to supply is controlled. Thus, because the power to supply is controlled in accordance with the change in the reception conditions over a long time period to a certain extent, the power to supply is properly controlled. The mean value may be a mean value per unit signal or a mean value per unit time.

In the present invention, it is preferable that the judging unit decides that the reception conditions of the received signal are good in the predetermined time period, when any of the mean values repeatedly calculated by the calculating unit in the predetermined time period indicates that the noises have become not more than the predetermined reference quantity. According to this feature, when the reception conditions temporarily change, the power to supply is not changed. Only when the mean value indicates for a certain time period that the quantity of corrected noises is not more than the reference quantity, the power to supply is changed. This makes it more surely to properly control the power to supply.

In the present invention, the judging unit may judge whether or not the reception conditions are good, on the basis of a relation between the variance of the whole of the values repeatedly calculated by the calculating unit in the predetermined time period, and a value indicating that the noises have become not more than the predetermined reference quantity. According to this feature, on the basis of in what manner the plurality of calculated values are distributed, the power to supply is properly controlled.

In the present invention, it is preferable that the correcting unit comprises a wave equalizing unit that applies wave equalization to each unit signal contained in a train of the received signal, and the calculating unit calculates a modulation error ratio (MER) with respect to the wave equalization applied by the wave equalizing unit, as the value indicating the quantity of noises. When wave equalization is performed, the MER can easily be calculated. This realizes a simple construction of the calculating unit.

### BRIEF DESCRIPTION OF THE DRAWINGS

Other and further objects, features and advantages of the invention will appear more fully from the following description taken in connection with the accompanying drawings in which:

FIG. 1A is an external view of a cellular phone according to a first embodiment of the present invention;

FIG. 1B is a block diagram showing a general electrical constitution of the cellular phone;

FIG. 2 is a block diagram showing a constitution of a tuner shown in FIG. 1B;

FIG. 3 is a block diagram showing a constitution of a demodulator shown in FIG. 1B;

FIG. 4 is a block diagram showing a constitution of a controller shown in FIG. 1B;

FIG. 5 is a flowchart showing processing to be performed by the controller of FIG. 4;

FIGS. 6A to 6C are flowcharts of subroutines to be called in the procedure of FIG. 5; and

FIG. 7 is a flowchart according to a second embodiment of the present invention.

### DESCRIPTION OF THE PREFERRED EMBODIMENTS

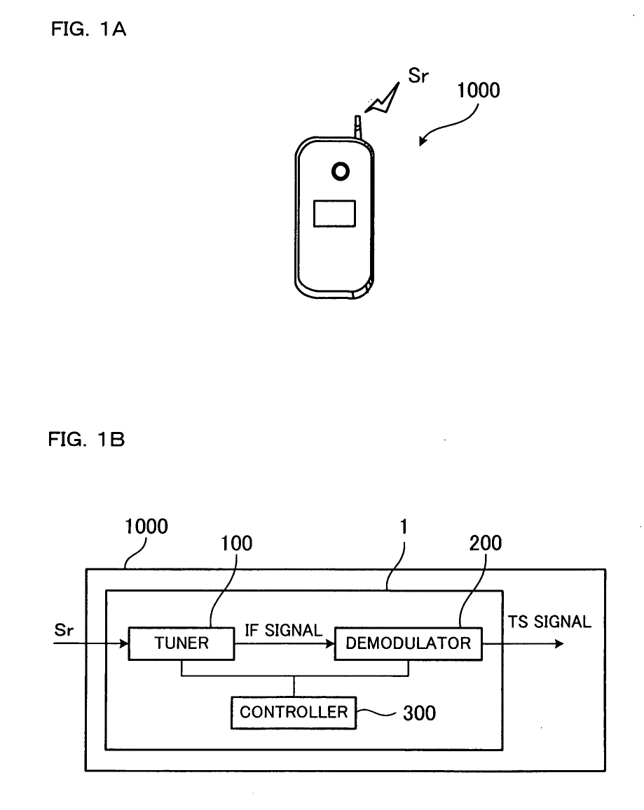

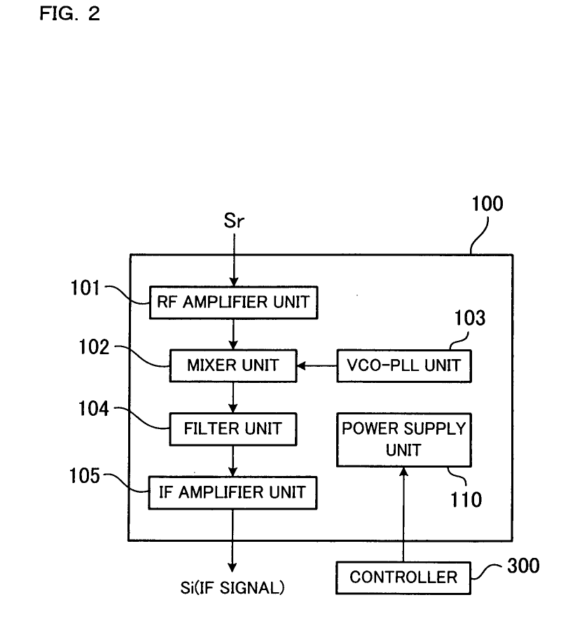

Hereinafter will be described preferred embodiments of the present invention. FIG. 1A shows an external view of a cellular phone 1000 according to a first embodiment of the present invention. FIG. 1B shows a general constitution of a digital demodulating apparatus 1 included in the cellular phone 1000.

The cellular phone 1000 of this embodiment includes therein a digital demodulating apparatus 1. The digital demodulating apparatus 1 demodulates a signal Sr received by the cellular phone 1000 through its antenna. Information on data of characters, an image, sound, or a program, is taken out from a demodulated signal output from the digital demodulating apparatus 1, and the data is reproduced. The characters, image, and so on, are provided to a user of the cellular phone 1000 through a not-shown display and a not-shown speaker provided on the phone 1000. In a modification, the digital demodulating apparatus 1 may be adopted in another digital receiver than such a cellular phone, for example, a digital television (TV) receiver, a wireless local area network (LAN) device, or a personal computer (PC) using wireless LAN.

The digital demodulating apparatus 1 includes therein a tuner 100, a demodulator 200, and a controller 300. The tuner 100 is electrically connected to the demodulator 200. The tuner 100 is also electrically connected to an antenna and applies channel select processing to a signal Sr received through the antenna. That is, the tuner 100 selects a single channel out of a number of channels contained in the signal Sr, and receives the single channel. The tuner 100 then converts the signal of the selectively received channel into an intermediate frequency (IF) signal, which is sent to the demodulator 200. The demodulator 200 receives the IF signal sent from the tuner 100; demodulates the IF signal; and then outputs the demodulated signal. The demodulated signal is, for example, a so-called transport stream (TS) signal.

The digital demodulating apparatus 1 is made up of a number of circuit elements. If not otherwise specified in the below description, each circuit element may be constituted by a group of circuit components specialized so as to serve an independent function; or may be realized by hardware components such as a general-purpose processor, and computer programs that cause the hardware components such as the processor to operate so as to serve the respective functions as will be described later. In the latter case, each circuit element is realized by combining the hardware components and the computer programs.

Next will be described a signal train to be received by the cellular phone 1000. The signal train to be received by the cellular phone 1000 is transmitted by a number of carrier waves. In the below example of this embodiment, the orthogonal frequency division multiplexing (OFDM) method is adopted for transmitting the signal train to be received by the cellular phone 1000.

A signal according to the OFDM method is in the form of a signal train in which a large number of symbols each having a prescribed length are sequentially arranged. Each symbol contains a number of unit signals superimposed on each other. The unit signals are obtained by modulating carrier waves different in frequency, in accordance with data having a predetermined data length. Each symbol contains a guard interval at a portion other than the effective portion that contains data. The guard interval that has quite the same signal component as a portion of the rear end of the effective portion, is disposed at the front end of the symbol. The guard interval is used for removing from the received signal the influence of a number of multipath waves generated in the transmission path from a transmission station that transmitted the signal train, to the cellular phone 1000. The length of the effective portion contained in one symbol is called effective symbol length.

The OFDM signal further contains a number of scattered pilot signals. When the unit signals contained in the signal train are arranged in a plane defined by an axis of time and an axis of frequency, the scattered pilot signals contained in the OFDM signal are arranged at regular intervals along either of the axis of time and the axis of frequency. The scattered pilot signals form a numeric sequence that is represented according to a prescribed coding method or the like, and has been inserted in the signal train in a predetermined arrangement order. In other words, the scattered pilot signals are arranged in the signal train so that the numeric sequence represented according to the prescribed coding method is reproduced when the numeric values indicated by the respective scattered pilot signals are taken in the predetermined arrangement order in the signal train.

Further, the signal train supposed in this embodiment has received various kinds of interleaving and various kinds of coding in order that error correction can be performed to correct errors generated in the signal train. For example, for coding, Reed-Solomon (RS) coding and Viterbi coding are used. For interleaving used are bit interleaving, byte interleaving, time interleaving, and frequency interleaving. Interleaving as described above is to rearrange temporally or in frequency, data corresponding to signals contained in a transmitted signal. By applying demodulation processing and deinterleave processing, which will be described later, in the cellular phone 1000 to the signal train to which various kinds of coding and various kinds of interleaving have been applied, errors contained in the signal train can be corrected.

For the signal train supposed in this embodiment, a transmission system according to Japanese digital terrestrial broadcasting is. For Japanese digital terrestrial broadcasting, the integrated services digital broadcasting-terrestrial (ISDB-T) system is adopted.

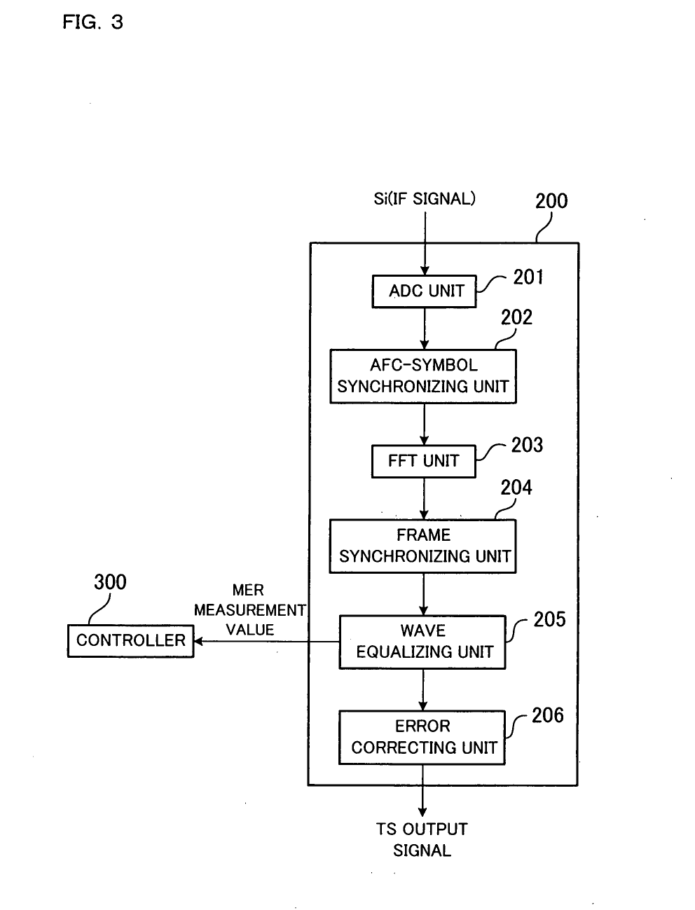

FIG. 2 is a block diagram showing a constitution of the tuner 100. The tuner 100 includes therein an RF amplifier unit 101, a mixer unit 102, a VCO-PLL unit 103, a filter unit 104, and an IF amplifier unit 105. The signal Sr input to the tuner 100 is amplified by the RF amplifier unit 101, and then output to the mixer unit 102. The VCO-PLL unit 103 generates a mixing signal based on a frequency corresponding to a specific channel, which is channel select processing. The mixing signal generated by the VCO-PLL unit 103 is output to the mixer unit 102. The mixer unit 102 generates an IF signal Si according to an IF frequency from the signal Sr output from the RF amplifier unit 101 and the mixing signal from the VCO-PLL unit 103.

The IF signal Si generated by the mixer unit 102 is output to the filter unit 104. The filter unit 104 removes unnecessary signal components from the signal Si output from the mixer unit 102. The signal Si from which the unnecessary signal components have been removed, is output to the IF amplifier unit 105. The IF amplifier unit 105 amplifies the signal Si output from the filter unit 104, and then outputs the amplified signal Si to the demodulator 200.

The tuner 100 further includes therein a power supply unit 110. The power supply unit 110 supplies power to each of the RF amplifier unit 101, the mixer unit 102, the filter unit 104, and the IF amplifier unit 105. The RF amplifier unit 101 and so on operate by the respective powers supplied from the power supply unit 110. The power supply unit 110 stores therein data of Table 1 as will be described below, which indicates the intensities of the powers to be supplied to the RF amplifier unit 101 and so on.

The Table 1 contains n sets of current values, each of which sets is constituted by current values corresponding to the respective units of the RF amplifier unit 101 to the IF amplifier unit 105. The current values contained in the Table 1, such as Ir1 to Irn and Im1 to Imn, have been set so as to satisfy the conditions of Ir1 not less than Ir2 not less than Ir3 . . . not less than Irn, which is less than Ir1; Im1 not less than Im2 not less than Im3 . . . not less than Imn, which is less than Im1; and so on. In short, the current values have been set so as to stepwise decrease from the upper row to the lower row in the Table 1.

The power supply unit 110 stores therein one of 1 to n that indicates the present set number. By referring to the Table 1, the power supply unit 110 supplies currents of the current values of the set corresponding to the present set number to the RF amplifier unit 101 to the IF amplifier unit 105 corresponding to the respective current values. For example, when the present set number is 3, the power supply unit 110 supplies a current of Ir3 to the RF amplifier unit 101; a current of Im3 to the mixer unit 102; and so on. The controller 300 sends to the power supply unit 110 a signal that instructs the power supply unit 110 to update the present set number to a new set number. When receiving the signal, the power supply unit 110 updates the present set number to the new set number indicated by the signal from the controller 300.

TABLE 1

| | RF amplifier | | |
|---|---|---|---|
| Set No. | unit | Mixer unit | . . . |
| 1 | Ir1 | Im1 | . . . |
| 2 | Ir2 | Im2 | . . . |
| 3 | Ir3 | Im3 | . . . |
| . | . | . | . |
| . | . | . | . |
| . | . | . | . |
| n | Irn | Imn | . . . |

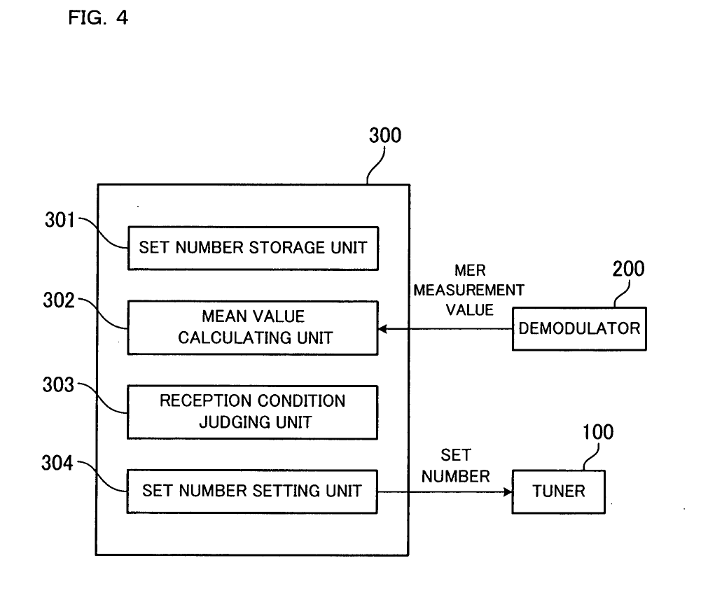

Next will be described the demodulator 200. FIG. 3 is a block diagram showing a constitution of the demodulator 200. As shown in FIG. 3, the demodulator 200 is constituted by a number of circuit elements such as an ADC unit 201 as will be described below.

The demodulator 200 includes therein an ADC unit 201, an AFC-symbol synchronizing unit 202, a fast Fourier transform (FFT) unit 203, a frame synchronizing unit 204, a wave equalizing unit 205, and an error correcting unit 206. The IF signal Si output from the tuner 100 is input to the ADC unit 201. The ADC unit 201 converts the input analogue signal Si into a digital signal, and outputs the converted digital signal to the AFC-symbol synchronizing unit 202.

The AFC-symbol synchronizing unit 202 applies filter processing and so on to the digital signal output from the ADC unit 201. The AFC-symbol synchronizing unit 202 determines the start point of Fourier transform by the FFT unit 203 as will be described later, that is, a symbol synchronization point, and executes symbol synchronization. The AFC-symbol synchronizing unit 202 then outputs the synchronized digital signal to the FFT unit 203. In a modification, the AFC-symbol synchronizing unit 202 may send information on the symbol synchronization point to the controller 300. In another modification, the AFC-symbol synchronizing unit 202 may derive information on a mode indicating an effective symbol length, and send the information to the controller 300.

In the ISDB-T system, modes indicating effective symbol lengths include a mode 1 of an effective symbol length of 252 microseconds, a mode 2 of an effective symbol length of 504 microseconds, and a mode 3 of an effective symbol length of 1008 microseconds. When the symbol synchronization point is determined, a point that makes it possible to realize the most suitable reception having the least affection of multipath waves, is set to the synchronization point. As a method of determining the synchronization point, a method is used in which correlation of signals is referred to; in which phase shift is corrected by using pilot signals such as scattered pilot signals; or the like.

The FFT unit 203 converts by time-frequency Fourier transform the digital signal output from the AFC-symbol synchronizing unit 202. For this Fourier transform, so-called fast Fourier transform (FFT) is used in general. The FFT unit 203 sequentially outputs digital signals to which Fourier transform has been applied, to the frame synchronizing unit 204.

The frame synchronizing unit 204 synchronizes each digital signal output from the FFT unit 203, in a unit of frame. One frame is constituted by, for example, 204 symbols, and a batch of TMCC information is obtained from one frame signal. The digital signal synchronized by the frame synchronizing unit 204 is output to the wave equalizing unit 205.

On the basis of scattered pilot signals contained in the digital signal, the wave equalizing unit 205 applies wave equalization to the digital signal synchronized by the frame synchronizing unit 204. The wave equalization is a kind of signal corrections to correct a shift of constellation from a reference value, that has occurred in each unit signal. The shift of constellation from the reference value mainly occurs due to noise generated on the signal transmission path.

The wave equalization is performed as follows. First, the wave equalizing unit 205 extracts scattered pilot signals out of the signal train output from the frame synchronizing unit 204. On the other hand, the wave equalizing unit 205 sequentially generates, as reference signals, signals that indicate the numeric sequence based on the prescribed coding method used for the scattered pilot signals. The wave equalizing unit 205 then divides each extracted scattered pilot signal by the corresponding reference signal generated.

Next, the wave equalizing unit 205 interpolates the above division results along either of an axis of time and an axis of frequency. For the interpolation used is a linear interpolation method, a maximum likelihood estimation method, or the like. The wave equalizing unit 205 then divides by each interpolated numeric value the corresponding unit signal contained in the signal train output from the frame synchronizing unit 204. The wave equalization is thus applied to the signal train. The unit signals to which the wave equalization has been applied are demapped to data items each having a predetermined data length. The result of demapping is output to the error correcting unit 206.

On the other hand, when demapping the signal train, the wave equalizing unit 205 measures for each unit signal the difference of the constellation of the signal train to which the wave equalization has been applied, from the reference value of the constellation, that is, the modulation error ratio (MER). The MER indicates an error of the constellation of the received signal. In this embodiment, the specific value of the MER is calculated so that the larger value indicates the smaller amount of noises to the intensity of the received signal. The MER measurement values measured by the wave equalizing unit 205 for the respective unit signals are output to the controller in the order of the wave equalizations applied.

The error correcting unit 206 applies error correction to the signal output from the wave equalizing unit 205. The error correction is performed by deinterleaving and decoding corresponding to interleaving and coding applied to the signal on the transmission side. The digital signal to which various kinds of interleaving have been applied is restored by deinterleaving to the digital signal before interleaving. In addition, the coded digital signal is restored by decoding to the digital signal before coding. Thereby, various kinds of errors are corrected that are contained in the signal by passing through the transmission path. In a modification, the error correcting unit 206 may measure the quantity of error corrections when applying the error correction to the digital signal, and calculate the bit error rate (BER). The calculated BER may be output to the controller 300.

The digital signal to which the demodulator 200 has applied demodulation as described above is output from the demodulator 200 as a TS signal.

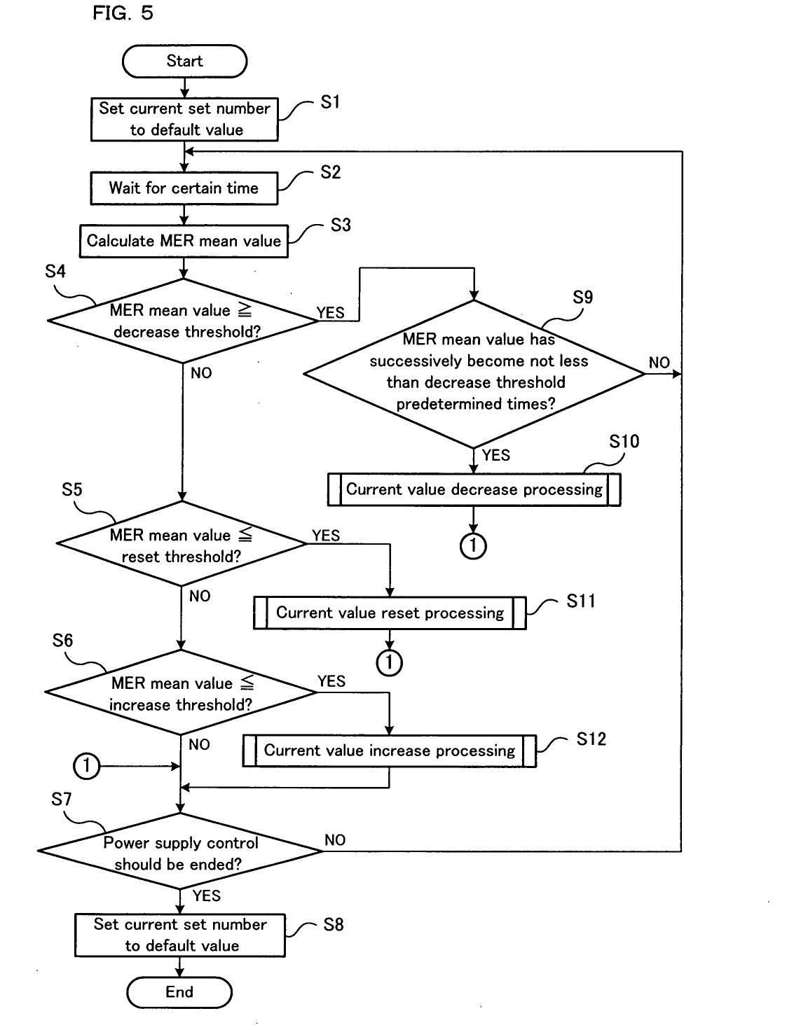

FIG. 4 is a block diagram showing a constitution of the controller 300. The controller 300 includes hardware components such as a processor and memories, and software components including computer programs and various kinds of data items to cause the hardware components to serve as a set number storage unit 301, a mean value calculating unit 302, a reception condition judging unit 303, and a set number setting unit 304.

The set number storage unit 301 stores therein one of natural numbers 1 to n. The stored natural number corresponds to the present set number in the sets of current values of the above Table 1. The mean value calculating unit 302 calculates a mean value of MER on the basis of data indicating MER measurement values sent from the demodulator 200. The mean value is a mean value, for each unit signal, of a number of MER measurement values measured when wave equalization is applied to a predetermined number of unit signals. On the basis of the mean value calculated by the mean value calculating unit 302, the reception condition judging unit 303 judges whether or not the present signal reception conditions are good. The set number setting unit 304 determines a set number on the basis of the result of the judgment of the reception condition judging unit. The set number setting unit 304 then sends data indicating the set number, to the tuner 100, and instructs the set number storage unit 301 to store the data indicating the set number.

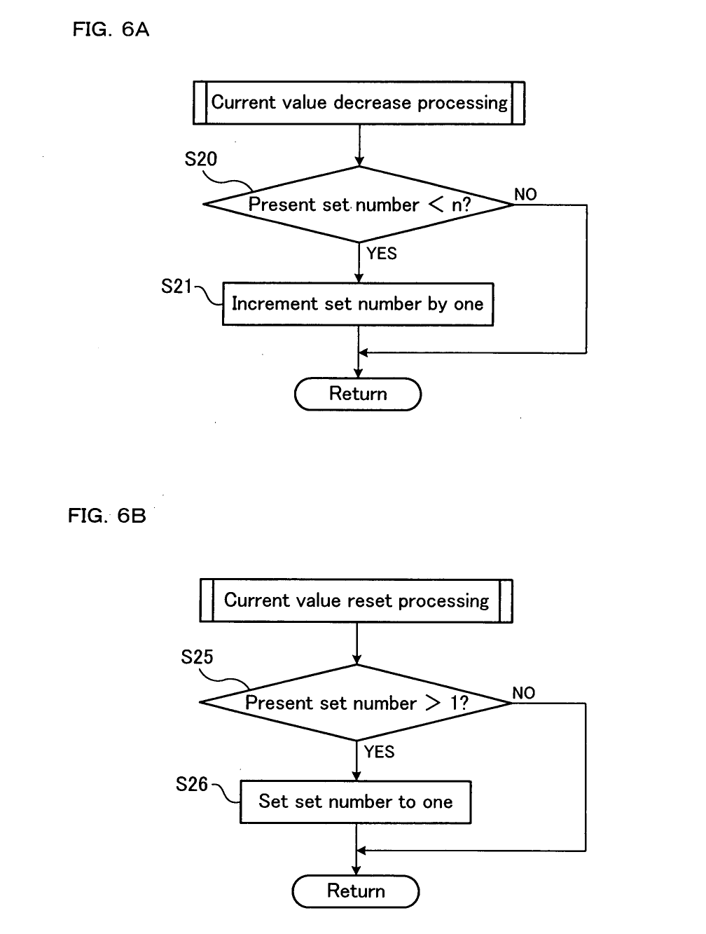

FIG. 5 is a flowchart showing processing to be performed by the functional components of the controller 300. Processing of FIG. 5 is started when conditions are satisfied for the controller 300 performing power supply control. For example, processing of FIG. 5 is started at a timing when the cellular phone 1000 starts receiving a specific broadcasting.

First, in Step S1, the controller 300 sets a default set number in the set number storage section 301, and sends to the tuner 100 a signal to instruct to set the set number to 1. The default set number is 1. That is, of the sets shown in the Table 1, the set of the largest current values is default.

Next, in Step S2, the controller 300 waits for a certain time period. In Step S3, the mean value calculating unit 302 calculates a mean value of MER. The mean value is calculated by, for example, summing up a predetermined number of MER measurement values sequentially sent from the demodulator 200, and dividing the sum by the number of MER measurement values.

Next, in Step S4, the reception condition judging unit 303 judges whether or not the MER mean value calculated by the mean value calculating unit 302 in Step S3 is not less than a predetermined decrease threshold. The MER mean value having reached the decrease threshold indicates that the quantity of noises contained in the received signal has reached a certain reference quantity to the intensity of the received signal. The reference quantity has been preferably set to be sufficiently smaller than the limit value of the noise quantity for accurately demodulating the received signal by the demodulator 200. The reason is as follows. In the case that the reference quantity has been thus set, when the MER mean value exceeds the decrease threshold, noises are sufficiently less than the limit quantity that makes accurate demodulation impossible. Therefore, even when the power to supply is decreased in the tuner 100, no problem arises in demodulation.

When the reception condition judging unit 303 decides that the MER mean value is not less than the decrease threshold, that is, YES in Step S4, the flow advances to Step S9, in which the reception condition judging unit 303 judges whether or not the MER mean value has successively become not less than the decrease threshold a predetermined number of times, for example, five times. When the reception condition judging unit 303 decides that MER mean value has not successively become not less than the decrease threshold the predetermined number of times, that is, NO in Step S9, the controller 300 again executes processing from Step S2. When the reception condition judging unit 303 decides that the MER mean value has successively become not less than the decrease threshold the predetermined number of times, that is, YES in Step S9, the controller 300 executes current value decrease processing of Step S10 and then processing of Step S7.

As described above, even when the reception condition judging unit 303 decides that the MER mean value became not less than the predetermined decrease threshold in a series of processing of Steps S2 to S4 and S9, the reception condition judging unit 303 does not immediately decide that the reception conditions are good. The calculation of the MER mean value is repeated a number of times. Only when the calculated MER mean value has successively become not less than the decrease threshold the predetermined number of times, the reception condition judging unit 303 decides that the reception conditions are good, and then current value decrease processing is executed. In other words, only when good reception conditions stably continued for a predetermined time period after the MER mean value once became not less than the decrease threshold, the reception condition judging unit 303 decides that the reception conditions are good.

When the reception condition judging unit 303 decides in Step S4 that the MER mean value is less than the decrease threshold, that is, NO in Step S4, the flow advances to Step S5, in which the reception condition judging unit 303 judges whether or not the MER mean value is not more than a predetermined reset threshold that is less than the decrease threshold. When the reception condition judging unit 303 decides that the MER mean value is not more than the reset threshold, that is, YES in Step S5, the controller 300 executes current value reset processing of Step S11 and then processing of Step S7. When the reception condition judging unit 303 decides that the MER mean value is more than the reset threshold, that is, NO in Step S5, the flow advances to Step S6, in which the reception condition judging unit 303 judges whether or not the MER mean value is not more than a predetermined increase threshold that is more than the reset threshold and less than the decrease threshold. When the reception condition judging unit 303 decides that the MER mean value is not more than the increase threshold, that is, YES in Step S6, the controller 300 executes current value increase processing of Step S12 and then processing of Step S7. When the reception condition judging unit 303 decides that the MER mean value is more than the increase threshold, that is, NO in Step S6, the controller 300 executes processing of Step S7.

In Step S7, the controller 300 judges whether or not a series of power supply control steps should be ended. When the controller 300 decides that a condition for ending the series of power supply control steps is satisfied, for example, when reception of a specific broadcasting ends, that is, YES in Step S7, the flow advances to Step S8, in which the controller 300 sets the current set number to 1 as the default value; instructs the set number storage unit 301 to store the current set number; and sends to the tuner 100 a signal to instruct the tuner 100 to set the current set number to 1. The series of power supply control steps then end. When the controller 300 decides in Step S7 that the series of power supply control steps should be continued, that is, NO in Step S7, the controller 300 again executes processing from Step S2.

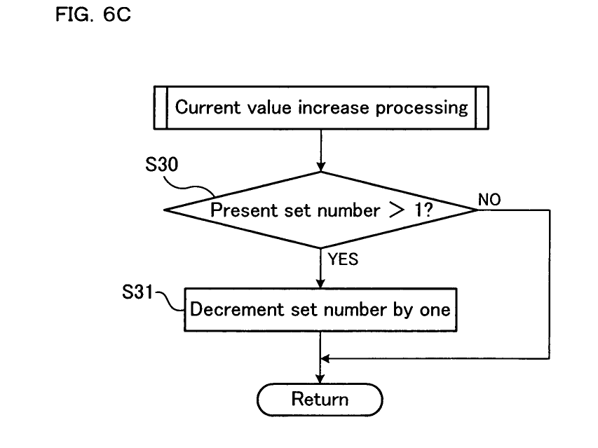

FIGS. 6A to 6C are flowcharts of current value decrease processing, current value reset processing, and current value increase processing, to be called in the procedure of FIG. 5. When current value decrease processing is called, first, in Step S20, the set number setting unit 304 judges whether or not the present set number stored in the set number storage unit 301 is less than n. When the set number setting unit 304 decides that the present set number is not less than n, that is, NO in Step S20, current value decrease processing then ends. When the set number setting unit 304 decides that the present set number is less than n, that is, YES in Step S20, the flow advances to Step S21, in which the set number setting unit 304 instructs the set number storage unit 301 to increment the stored set number by one; and sends to the tuner 100 a signal to instruct the tuner 100 to update the present set number to the new set number incremented by one. Thereby, the whole power to supply in the tuner 100 is reduced. Current value decrease processing then ends.

When current value reset processing is called, first, in Step S25, the set number setting unit 304 judges whether or not the present set number stored in the set number storage unit 301 is more than 1. When the set number setting unit 304 decides that the present set number is not more than 1, that is, NO in Step S25, current value reset processing then ends. When the set number setting unit 304 decides that the present set number is more than 1, that is, YES in Step S25, the flow advances to Step S26, in which the set number setting unit 304 instructs the set number storage unit 301 to store the default value of 1; and sends to the tuner 100 a signal to instruct the tuner 100 to update the present set number to 1. Current value reset processing then ends.

When current value increase processing is called, first, in Step S30, the set number setting unit 304 judges whether or not the present set number stored in the set number storage unit 301 is more than 1. When the set number setting unit 304 decides that the present set number is not more than 1, that is, NO in Step S30, current value increase processing then ends. When the set number setting unit 304 decides that the present set number is more than 1, that is, YES in Step S30, the flow advances to Step S31, in which the set number setting unit 304 instructs the set number storage unit 301 to decrement the stored set number by one; and sends to the tuner 100 a signal to instruct the tuner 100 to update the present set number to the new set number decremented by one. Thereby, the whole power to supply in the tuner 100 is increased. Current value increase processing then ends.

As described above, in this embodiment, even when the MER mean value becomes not less than the decrease threshold only once, it is not immediately decided that the reception conditions are good. Only when the MER mean value becomes not less than the decrease threshold a predetermined number of times, it is decided that the reception conditions are good, and the power to supply is reduced. In other words, only when it is decided that the MER mean value stably continued for a predetermined time period, it is decided that the reception conditions are good. Thus, even when the MER mean value temporarily becomes not less than the decrease threshold, the power to supply is not immediately changed. This makes the power supply stable. In addition, because the power to supply is reduced when the reception conditions are good, this suppresses the power consumption of the whole of the cellular phone 1000.

When the MER mean value becomes not more than the increase threshold that is less than the decrease threshold, processing for increasing the power to supply is performed. Therefore, the power to supply, which has been once decreased, is increased as the reception conditions deteriorate. This ensures accurate demodulation of the received signal. Further, when the MER mean value becomes not more than the reset threshold that is less than the increase threshold, the intensity of the power to supply is set to the default set value of 1, which is the set of the largest current values. Therefore, even when the reception conditions sharply deteriorate, proper control of the power to supply is performed to cope with the sharp deterioration of the reception conditions.

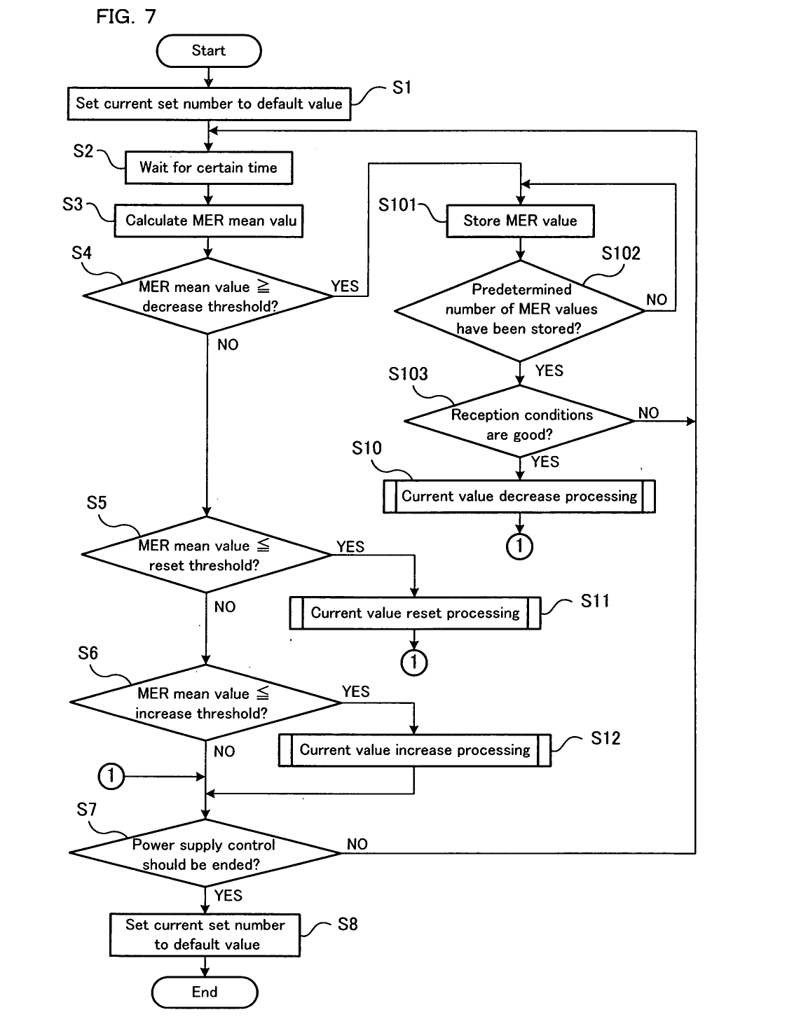

Next will be described a second embodiment of the present invention. The second embodiment differs from the first embodiment only in processing of the reception condition judging unit 303 judging the reception conditions to be good. FIG. 7 is a flowchart showing processing to be performed by the controller 300 in the second embodiment, corresponding to FIG. 5. In FIG. 7, steps that are the same in processing as those in FIG. 5 are denoted by the same step numbers as in FIG. 5, respectively, for example, Step S1 and so on. In the below, the description of the same constitution and processing as the first embodiment will be omitted.

The flow of FIG. 7 differs from the flow of FIG. 5 in Steps S101 to S103. When the reception condition judging unit 303 decides in Step S4 that the MER mean value becomes not less than the decrease threshold, that is, YES in Step S4, the flow advances to Step S101, in which the mean value calculating unit 302 stores one by one the MER value sent from the demodulator 200. The mean value calculating unit 302 repeats the accumulation of the MER values till the mean value calculating unit 302 decides that a predetermined number of MER values have been stored, that is, the flow returns to Step S101 when the judgment result in Step S102 is NO. When the predetermined number of MER values have been stored, that is, YES in Step S102, the flow advances to Step S103, in which the mean value calculating unit 302 calculates the mean value of the accumulated MER values and the variance of the MER values. Further, on the basis of the variance of the MER values calculated by the mean value calculating unit 302, the reception condition judging unit 303 judges in Step S103 whether or not the reception conditions are good.

More specifically, the mean value calculating unit 302 calculates the variance of the MER values, and the reception condition judging unit 303 estimates the distribution of the MER values on the basis of the variance. For example, the reception condition judging unit 303 has an assumption that the distribution of the MER values is the normal distribution. On the basis of the variance calculated by the mean value calculating unit 302, the reception condition judging unit 303 calculates the ratio of a portion of the normal distribution that is more than the decrease threshold, to the whole distribution. When the ratio is not less than a predetermined ratio, the reception condition judging unit 303 decides that the reception conditions are good, that is, YES in Step S103. When the ratio is less than the predetermined ratio, the reception condition judging unit 303 decides that the reception conditions are not good, that is, NO in Step S103. When the reception condition judging unit 303 decides that the reception conditions are good, the controller 300 executes current decrease processing of Step S10. When the reception condition judging unit 303 decides that the reception conditions are not good, the controller 300 executes processing from Step S2.

That is, in the second embodiment, when it is decided that the MER mean value has become not less than the decrease threshold, a number of MER values, for example, 500 MER values, are accumulated in a predetermined time period after the decision. The distribution of the MER values is estimated from the variance of the MER values. In accordance with whether or not the ratio of a portion of the distribution that is not less than the decrease threshold is not less than a predetermined ratio, it is judged whether or not the reception conditions are good. For example, when the normal distribution is statistically assumed and the mean value and the variance are represented by mu and squared sigma, respectively, it is judged by a threshold of mu plus/minus 2 sigma whether or not the reception conditions are good, because 95.4% of the distribution of the MER values fall within the range of mu plus/minus 2 sigma. Thus, on the basis of in what manner the MER values are distributed, it can be properly grasped whether or not the reception conditions are good.

Preferred embodiments of the present invention have been described above. However, the present invention is never limited to the above-described embodiments. Various changes can be made within the scope of the invention.

For example, in the above-described embodiments, the current to be supplied to each circuit element of the tuner 100 is controlled. In a modification, however, the voltage may be controlled.

In a modification, in Step S9 of FIG. 5, it may be decided that the reception conditions are good, when the MER mean value is calculated a predetermined number of times and the ratio of the MER mean values more than the decrease threshold exceeds a predetermined ratio. In another modification, in Step S9 of FIG. 5, it may be decided that the reception conditions are good, when the MER mean value and the variance are calculated a predetermined number of times and the value of mu plus/minus 2 sigma exceeds a predetermined value in any of time zones set in advance. In another modification, in Step S103 of FIG. 7, it may be decided that the reception conditions are good, when the ratio of the number of MER values not less than the decrease threshold to the number of whole accumulated MER values exceeds a predetermined ratio.

In the above-described embodiments, on the basis of MER measured in the wave equalizing unit 205, it is judged whether or not the reception conditions are good. In a modification, however, it may be judged whether or not the reception conditions are good, on the basis of BER calculated when the error correcting unit 206 executes error correction. Like the wave equalization, the error correction is one of corrections to be performed for accurate demodulation of the received signal.

In the above-described embodiments, the ISDB-T system is adopted as digital terrestrial broadcasting. However, other than the ISDB-T system, the present invention can be applied to various kinds of transmission systems such as the digital audio broadcasting (DAB) system, the digital video broadcasting-terrestrial (DVB-T) system, the digital video broadcasting-handheld (DVB-H) system, the digital multimedia broadcasting (DMB) system, and the IEEE802.11a/b/g/n system used for a wireless LAN.

The present invention may be implemented by a computer program product that causes hardware components including a general-purpose processor to execute the functions of the digital demodulating apparatus 1. Such computer program products can be distributed in a form of being recorded on computer-readable recording media including removable type recording media such as compact disc read only memory (CD-ROM) disks, flexible disks (FDs), and magneto optical (MO) disks, and fixed type recording media such as hard disks. The computer program products can be also distributed by wired or wireless electric communication means via a communication network such as the Internet. Such a computer program product may not be exclusive to the digital demodulating apparatus. By using in combination with computer programs for channel select processing and digital demodulation processing, the computer program product may cause a general-purpose information processing apparatus to function as the digital demodulating apparatus.

The present invention can be applied to various digital receivers, such as digital television receivers, that reproduce at least one of characters, images, data such as computer programs, and sounds. Such a digital receiver acquires information on characters, images, data such as computer programs, or sounds, from a demodulated signal train, and then the receiver reproduces the characters or the like. According to this construction, because the characters or the like are reproduced from the properly demodulated signal train, the accuracy of the reproduction is improved.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A digital demodulating apparatus comprising:
a plurality of circuit elements constituting a receiving unit and a demodulating unit that demodulates a signal received by the receiving unit;
a supplying unit that supplies power to each circuit element;
a correcting unit that corrects errors due to noises generated on a transmission path of the received signal;
a calculating unit that calculates a value indicating the quantity of noises contained in the signal when the correcting unit corrects the errors;
a judging unit that judges whether or not reception conditions of the received signal are good in a predetermined time period, on the basis of values repeatedly calculated by the calculating unit in the predetermined time period after a value calculated by the calculating unit indicates that the noises have become not more than a predetermined reference quantity; and
a reducing unit that reduces the power to be supplied to each circuit element by the supplying unit, when the judging unit decides that the reception conditions are good.

2. The apparatus according to claim 1, wherein the received signal is in the form of a signal train in which a plurality of unit signals each having a predetermined length are successively arranged,
the correcting unit corrects with respect to each unit signal the errors due to the noises generated on the transmission path of the signal train,
the calculating unit calculates a mean value of values indicating the respective quantities of noises with respect to a plurality of unit signals, on the basis of the quantities of corrections performed by the correcting unit with respect to the plurality of unit signals, and
the judging unit judges whether or not the reception conditions of the received signal are good in the predetermined time period, on the basis of mean values repeatedly calculated by the calculating unit in the predetermined time period after a mean value calculated by the calculating unit indicates that the noises have become not more than the predetermined reference quantity.

3. The apparatus according to claim 2, wherein the judging unit decides that the reception conditions of the received signal are good in the predetermined time period, when any of the mean values repeatedly calculated by the calculating unit in the predetermined time period indicates that the noises have become not more than the predetermined reference quantity.

4. The apparatus according to claim 1, wherein the judging unit judges whether or not the reception conditions are good, on the basis of a relation between the variance of the whole of the values repeatedly calculated by the calculating unit in the predetermined time period, and a value indicating that the noises have become not more than the predetermined reference quantity.

5. The apparatus according to claim 1, wherein the correcting unit comprises a wave equalizing unit that applies wave equalization to each unit signal contained in a train of the received signal, and
the calculating unit calculates a modulation error ratio (MER) with respect to the wave equalization applied by the wave equalizing unit, as the value indicating the quantity of noises.

6. A controlling method of a digital demodulating apparatus comprising a plurality of circuit elements constituting a receiving unit and a demodulating unit that demodulates a signal received by the receiving unit; and a supplying unit that supplies power to each circuit element, the method comprising:
a correcting step of correcting errors due to noises generated on a transmission path of the received signal;
a calculating step of calculating a value indicating the quantity of noises contained in the signal when the errors are corrected in the correcting step;
a judging step of judging whether or not reception conditions of the received signal are good in a predetermined time period, on the basis of values repeatedly calculated in the calculating step in the predetermined time period after a value calculated in the calculating step indicates that the noises have become not more than a predetermined reference quantity; and
a reducing step of reducing the power to be supplied to each circuit element by the supplying unit, when it is decided in the judging step that the reception conditions are good.
